(19) United States
(12) Patent Application Publication
(10) Pub. No.: US 2014/0105805 A1
(43) Pub. Date: Apr. 17, 2014

(54) PROCESS FOR HYDROGENATING SILICON TETRACHLORIDE TO TRICHLOROSILANE

(71) Applicant: Wacker Chemie AG, Muenchen (DE)

(72) Inventors: Walter HAECKL, Zeilarn (DE); Norbert ELLINGER, Postmuenster (DE); Andreas HIRSCHMANN, Ering (DE); Markus KAHLER, Kastl (DE); Uwe PAETZOLD, Burghausen (DE)

(73) Assignee: Wacker Chemie AG, Muenchen (DE)

(21) Appl. No.: 14/031,172

(22) Filed: Sep. 19, 2013

(30) Foreign Application Priority Data
Oct. 15, 2012 (DE) 102012218741.3

(51) Int. Cl. C01B 33/107

(52) U.S. Cl. CPC C01B 33/1071
USPC 423/342

(57) ABSTRACT

The invention provides a process for hydrogenating silicon tetrachloride in a reactor, in which reactant gas containing hydrogen and silicon tetrachloride is heated to a temperature of greater than 900° C. at a pressure between 4 and 15 bar, first by means of at least one heat exchanger made from graphite and then by means of at least one heating element made from SiC-coated graphite, the temperature of the heating elements being between 1150° C. and 1250° C., wherein the reactant gas includes at least one boron compound selected from the group consisting of diborane, higher boranes, boron-halogen compounds and boron-silyl compounds, the sum of the concentrations of all boron compounds being greater than 1 ppmv based on the reactant gas stream.

### BACKGROUND OF THE INVENTION

The invention relates to a process for hydrogenating silicon tetrachloride (STC) to trichlorosilane (TCS).

Trichlorosilane is typically prepared in a fluidized bed process from metallurgical silicon and hydrogen chloride. In order to obtain high purity trichlorosilane, this is followed by a distillation. This also affords silicon tetrachloride as a by-product.

The majority of silicon tetrachloride is obtained in the course of deposition of polycrystalline silicon.

Polycrystalline silicon is obtained, for example, by means of the Siemens process. This involves depositing silicon on heated thin rods in a reactor. The process gas used as the silicon-containing component is a halosilane such as trichlorosilane in the presence of hydrogen. The conversion of trichlorosilane (disproportionation) to deposited silicon gives rise to large amounts of silicon tetrachloride.

Silicon tetrachloride can be used, for example, to produce finely divided silica by reaction with hydrogen and oxygen at high temperatures in combustion chambers.

However, the use of greatest economic interest for silicon tetrachloride is hydrogenation to trichlorosilane. This is accomplished by reaction of silicon tetrachloride with hydrogen to give trichlorosilane and hydrogen chloride. This makes it possible to obtain trichlorosilane from the silicon tetrachloride by-product formed in the deposition, and to feed that trichlorosilane back to the deposition process, in order to obtain elemental silicon.

The hydrogenation of silicon tetrachloride with hydrogen to give trichlorosilane typically takes place in a reactor at high temperatures, at at least 600° C., ideally at at least 850° C. (high-temperature conversion).

In order to attain said high temperatures, heating elements manufactured from extremely heat-resistant material are needed. For this purpose, carbonaceous materials, for example graphite, are used. As will be shown hereinafter, particular problems are presented in the case of high-temperature treatments of hydrogen-containing gases which are heated by means of carbonaceous heating elements, and attention has already been drawn to these in the prior art.

In addition to the problems already described in the prior art, a new problem arises, and this is manifested particularly when the reactors are in operation for a comparatively long period. Thus, it has been observed that the electrical resistance of the heating elements rises continuously with increasing time. Since the desired constant electrical power is to be provided, this increase in resistance places additional technical demands on the power supply of the heating elements. It would therefore be more advantageous to prevent or at least to reduce the increase in the resistance of the heating elements.

U.S. Pat. No. 4,536,642 A discloses an apparatus for high-temperature treatment of gases, consisting of a heat-insulated housing with gas inlet and gas outlet orifices, and inert resistance heating elements heated by direct passage of current and arranged between these orifices. The heating elements consist of graphite. In addition, a heat exchanger unit composed of unheated gas outlets may be fitted into the housing, since it is advisable for energy-saving reasons to heat the reactants of the reaction with the aid of the hot offgases from the reactor. The hot offgases include products and unconverted reactants.

Such an apparatus is especially also suitable for hydrogenation of STC to TCS.

Because of the high thermal stability required, the heating elements used are manufactured from a suitable material. For thermal stability reasons, graphite is of good suitability in theory, but the carbon present reacts with the incoming hydrogen at the temperatures to give methane.

U.S. Pat. No. 7,442,824 B2 proposes, for example, coating the surface area of the heating elements with silicon carbide in situ prior to the hydrogenation of the chlorosilane and thus reducing methanization of these components. This step of coating with silicon carbide takes place at a temperature of at least 1000° C.

Nevertheless, in the case of coated graphite parts too, methanization and associated corrosion is still always observed. The reaction of the H₂/STC mixture with the carbon present in the heating elements to give other carbon-containing compounds such as methyltrichlorosilane and methyldichlorosilane also causes structural defects in the heating elements, which lead to reactor shutdowns and thus reduce the service life of the reactor.

Since the defective parts have to be replaced, this additionally means considerable financial expenditure because of the new procurement of the replacement parts required and the work involved in fitting them.

The methanization takes place particularly at the heating elements which are in direct contact with hydrogen and STC.

This is manifested by the increased occurrence of flakes and splinters which fall to the reactor base and can lead there in the worst case, for example, to shorting to ground, and hence to failure of the heating elements.

U.S. Pat. No. 7,998,428 B2 discloses an apparatus for supply of silicon tetrachloride and hydrogen reactant gases to a reaction space, in order to obtain a product gas comprising trichlorosilane and hydrogen chloride. The apparatus provides for positioning of reaction space and heating elements in a vessel which is supplied with argon. The reaction space and heating elements are accordingly within a pressurized outer vessel charged with argon. It is thus possible to prevent leakage of process gases. It is thus also possible to achieve the effect that the heating elements are not attacked by hydrogen.

However, a disadvantage is that the reaction space and the heating elements are separated from one another, and hence a higher temperature of the heating elements is required. This can in turn result in damage to the electrical bushing.

Moreover, the heating space has to have increased insulation to the outside, which increases the diameter of the plant.

Complex pressure regulation is likewise needed in order that hydrogen cannot penetrate into the heating space.

DE 199 49 936 A1 describes a process for protection of components made from graphite materials and carbon materials when they are used in hydrogen atmospheres at temperatures above 400° C., characterized in that methane is added to the hydrogen atmospheres in the ratio of the stoichiometric equilibrium between hydrogen and methane as a function of the prevailing temperature and of the pressure.

Even though it is suitable in principle for protection of the heating elements and heat exchangers, this additional methane introduction would, however, lead to increased formation of unwanted reaction products (methylchlorosilanes and hydrocarbons) in the hydrogenation of STC to TCS, and these cause a considerable level of distillation complexity for removal from the chlorosilanes.

US 2011/0110839 A1 relates to a process for preparing TCS by means of hydrochlorination from STC, metallurgical silicon and H₂, wherein the product gas mixture comprising TCS, STC, H₂, Si and metal salts is processed in several steps in order to separate TCS and STC from the other constituents, especially the solids.

The gas streams from the heating elements to the reactor may comprise hydrogen chloride, dichlorosilane, TCS, STC and impurities such as phosphorus chloride, phosphorus trichloride and boron trichloride, diborane, methane, phosphine and water. The temperature of the gas is about 580° C. and the pressure is 22.5 bar.

Under these reaction conditions, only insignificant methanization of the heating elements, if any, takes place. Only at higher temperatures and lower pressures does this effect occur. However, the overall process is nevertheless unsuitable for hydrochlorination of already very clean STC, which is obtained, for example, from the deposition, to TCS, since this is associated with considerable and avoidable cost and inconvenience for the purification.

U.S. Pat. No. 6,932,954 B2 discloses a process comprising deposition of polysilicon from TCS and H₂, TCS preparation by contacting of the offgas from the deposition with crude silicon, in the course of which silicon reacts with HCl present in the offgas, and processing of the offgas from the TCS preparation for removal of TCS, in order subsequently to supply TCS to the deposition. STC is present in the residues from the processing operation, and is hydrogenated with H₂ to give TCS. Hydrogen can be separated from the chlorosilanes by cooling. The hydrogen removed may comprise large amounts of boron compounds. These boron compounds can be removed by contacting the hydrogen with substances containing one of the functional groups —NR₂ (R being alkyl having 1-10 carbon atoms), —SO₃H, —COOH or —OH. Boron compounds in the chlorosilanes (boron halides) can be removed by distillation in order to reduce the boron content in the silicon and thus obtain silicon having the necessary qualitative properties.

Similarly to US 2011/0110839 A1, the TCS formation step takes place with the aid of crude silicon as a hydrochlorination. Under these reaction conditions, only insignificant methanization of the heating elements, if any, takes place. The material stream (H₂ and STC) which passes through the heating elements into the TCS formation step is not contaminated with impurities such as boron. The process has the disadvantage that the initially uncontaminated hydrogen has to be purified again in a complex manner after the TCS formation step before it can be used in the deposition.

US 2009/060819 A1 discloses a process in which by-product streams, for example from poly deposition and distillation, are processed, by purifying dirty STC in particular, which comprises STC and other high-boiling compounds, as a result of which the high-boiling compounds are removed, and hydrogenating it to TCS. The dirty STC is obtained in the purification of TCS (distillation, adsorption).

Since the crude material in the TCS synthesis is metallurgical silicon, the by-products also have impurities such as carbon compounds, boron compounds and phosphorus compounds. US 2009/060819 A1 envisages particularly clean STC (HP-STC) for the STC hydrogenation, this originating from a separate by-product chlorination and subsequent purification. The hydrogen used for the STC hydrogenation originates from the same source as that for the deposition and is thus particularly clean, since impurities in the silicon would otherwise impair the high quality of the product.

This process does not solve the problems which arise in the STC hydrogenation in the form of methanization of the heating elements.

U.S. Pat. No. 3,455,745 A relates to the coating of objects with tetraboron silicide (TBS), which is known to be extremely resistant to oxidation. In the case of objects made from silicon, hydrogen and boron trichloride or diborane are supplied to the object present in a reactor, as a result of which a TBS layer forms on the object. It is also possible to coat objects made from boron with TBS: for this purpose, for example, STC or other halosilanes and hydrogen (or TCS and H₂) are supplied. In both cases, which are combined according to the claims, the gases, i.e. hydrogen, STC/TCS and boron trichloride/diborane, are heated to a temperature of 1000-1200° C. Objects which do not consist of silicon or boron can also be coated with TBS. For this purpose, the object is initially coated with boron or with silicon. This is effected by pyrolytic decomposition of a boron or silicon compound. For example, a silicon layer was applied to a graphite rod by reduction of TCS with hydrogen. A TBS layer can be applied to this silicon layer by means of hydrogen and boron trichloride or diborane.

According to U.S. Pat. No. 3,455,745 A, at least one layer of silicon is needed on the surface of the object to be coated for the coating with TBS. In the case of an object consisting of graphite, a coating operation is therefore first undertaken by means of pyrolytic decomposition of trichlorosilane at a temperature of 1150° C., before the coating with TBS is commenced.

However, it has been found that the heating elements coated in this way have a variation of resistance with time already observed above, the effect of which is that increased demands are made of power supply, and this in turn has a very unfavorable effect on the economic viability of the process.

It was an object of the invention to provide a process for the hydrogenation of STC to TCS, in which the heating elements used do not exhibit a significant rise in resistance with time, but at the same time avoid the disadvantages of the prior art.

### DESCRIPTION OF THE INVENTION

The object is achieved by a process for hydrogenating silicon tetrachloride in a reactor, in which reactant gas comprising hydrogen and silicon tetrachloride is heated to a temperature of greater than 900° C. at a pressure between 4 and 15 bar, first by means of at least one heat exchanger made from graphite and then by means of at least one heating element made from SiC-coated graphite, the temperature of the heating elements being between 1150° C. and 1250° C., wherein the reactant gas includes at least one boron compound selected from the group consisting of diborane, higher boranes, boron-halogen compounds and boron-silyl compounds, the sum of the concentrations of all boron compounds being greater than 1 ppmv based on the reactant gas stream.

Preferred versions of the process are claimed in the dependent claims.

The process according to the invention surprisingly results in two effects which are not yet fully understood but are nevertheless reproducible.

Firstly, the heating element failures and hence reactor failures which are caused by flaking of the heating elements are drastically reduced. Secondly, the rise in the resistance of the heating elements with time is simultaneously reduced, the result of which is that it is no longer necessary to make any great demands on the power supply in the case of long run times of the reactors. This considerably reduces the capital costs.

As is known from the prior art, objects can in principle be coated with TBS using suitable processes, in order thus to increase resistance to oxidation. In the experiments conducted by the inventors, it was not possible to detect any TBS layer on the heating elements.

Even assuming that, analogously to U.S. Pat. No. 3,455,745 A, a TBS layer were to form, it could not explain the resistance characteristics of the heating elements over time. Switching a boron source on and off over time in an experiment shows clearly that the resistance profile against time can be observed to be much flatter with the boron source switched on than with the boron source subsequently switched off. This effect has very good reproducibility and leads, when the boron source is switched on and off several times, to a strictly monotonous rise in the resistance profile against time with an alternately flat and steep resistance profile. The possible formation of a TBS layer, which is known to have poor oxidizability and therefore only poor removability, could therefore not explain the steep rise in resistance immediately after the boron source had been switched off in any case.

In the case of hydrogenation of STC, hydrogen is generally used in excess (H₂:STC=2:1-10:1) and, after removal of the condensable chlorosilanes and HCl, is used again in the circulation flow as a reactant for STC hydrogenation.

As well as hydrogen from the recycling step, it is also possible to use pure hydrogen from a steam reformer or pure hydrogen from poly deposition.

These hydrogen types have a high purity, for example <10 ppmv of methane or <100 ppta of boron compounds.

In the recycling step for hydrogen from the STC hydrogenation, methane and other hydrocarbons accumulate (up to 5000 ppmv), whereas accumulation of boron compounds has not been observed.

It has been found that the different methane content in the various H₂ types (<10 ppmv or <5000 ppmv) apparently has no measurable effect on the methanization of the graphite components and heating elements. Damage to the components took place to a comparable degree. The resistance profile of the heating elements over time showed a similar profile for the different hydrogen types.

It can be assumed that, even in the case of a high CH₄ content (but below the equilibrium composition), it is not possible for a sufficiently dense or coherent SiC layer that protects the components from further attack by hydrogen or sustainably alters the resistance profile to form on the components.

However, it has been found that, surprisingly, even the addition of a small amount of diborane (B₂H₆) of approx. 1 ppmv to the hydrogen leads to a more favorable profile of the resistance-time curve of the heating elements. At the same time, this leads to significantly less damage to the heating elements.

In the customary processes for hydrogenation of STC to TCS, a boron input is avoided by using pure reactants (STC and H₂ from the poly deposition or STC and H₂ from the recycling steps). STC or H₂ from the poly deposition is inherently low in impurities, since, for example, boron compounds are depleted over polysilicon.

It has been suspected to date that an additional input of boron via the reactants of the STC hydrogenation leads to a rise in the boron concentration in the target product and hence causes a considerably higher level of complexity for the purifying distillation of the product.

Completely surprisingly, however, it has been found that the boron introduced additionally accumulates neither in the liquid (condensed) reaction product nor in the processed hydrogen.

This has also been confirmed by temporarily switching off the boron source, since the positive effect on the resistance profile of the heating elements decreased after a short time.

In the case of accumulation of boron in the system, a longer-lasting effect would have had to have been expected.

The boron supplied additionally in the experiment thus either has to be absorbed within the reactor, for example through incorporation into the SiC layer which forms, or discharged together with the hydrogen chloride obtained via the H₂ recycling step. Quantitative evidence of this is not possible. An SiC layer, and not a tetraboron silicide layer, forms on the heating elements.

For the inventive execution of the process, a boron compound can be supplied to the hydrogen reactant stream.

This can be effected, for example, by feeding in a defined amount of B₂H₆ or other gaseous boron compounds.

A further preferred variant of the invention consists in the feeding of a boron compound into the STC reactant stream.

Preference is given to supplying a boron compound which is liquid or soluble under the selected process conditions (temperature and pressure) to the STC stream, and this is then vaporized together with the chlorosilane.

It is unimportant for the success of the invention whether the boron compound supplied is more or less volatile than STC.

B-Halogen and B-silyl compounds, and also the higher boranes, are also decomposed at a temperature of more than 600° C. and lead to the same effects as diborane.

The damage to the heating elements can be quantified by the determination of the change in electrical resistance. The methanization reaction apparently increases the specific electrical resistivity of the typically graphite-containing heating element, and hence the total resistance of the heating element is also increased. A heating element arrangement with individual regulatable/controllable heating elements and individual electrical resistances of these heating elements which can be calculated from electrical current and electrical voltage was found here to be particularly advantageous.

This arrangement allows calculation and observation of the usually many individual heating element resistances. By observation of these resistances, it is possible to indirectly observe the heating element damage by the methanization reaction.

### BRIEF DESCRIPTION OF THE DRAWINGS

The invention is also illustrated hereinafter with reference to FIGS. 1-3.

FIG. 1 shows a plot of relative resistance against time for Examples A, B, C and D.

FIG. 2 shows a plot of relative resistance against time for Time Ranges E, F, G and H.

FIG. 3 shows a plot of relative resistance and temperature against time.

### EXAMPLES

The examples were conducted in an apparatus according to U.S. Pat. No. 4,536,642 A. A gas mixture in the reactant stream consisting of 33 mol % of silicon tetrachloride and 67 mol % of hydrogen was used. The inlet temperature of the reactant gas stream was about 175° C. The pressure was adjusted to 6 bar and the temperature of the gas in the reactor space to 1000° C.

In experiments, a boron compound, diborane, was metered in a controlled manner into the hydrogen and, at the same time, the change in the resistance was measured compared to the reference.

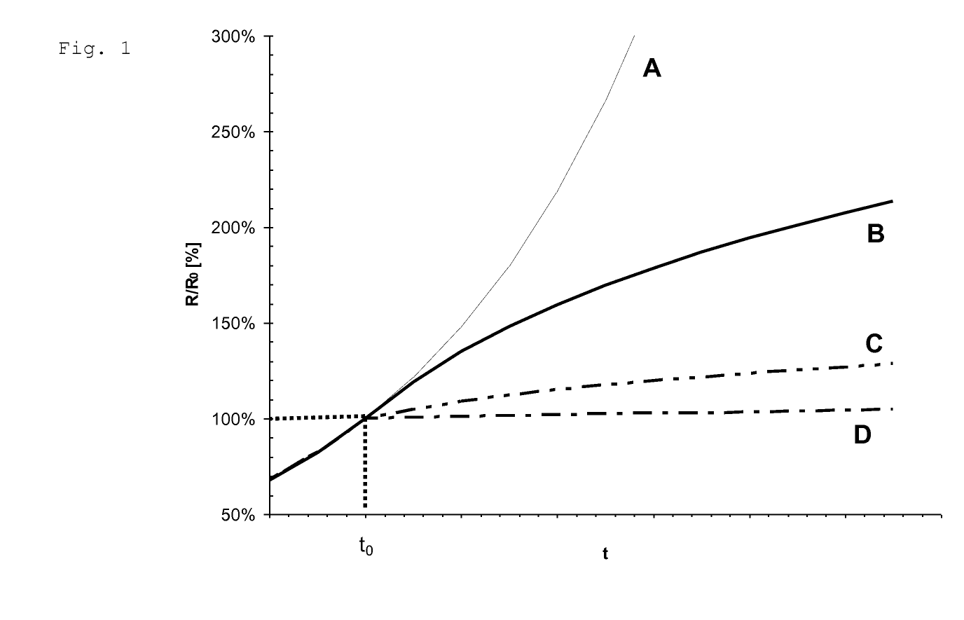

FIG. 1 shows the result in schematic form. On the abscissa is plotted the time t, while the ordinate shows the relative resistance R/R₀ in percent. From the time t₀, for cases B, C and D, diborane was additionally metered in. Case A was viewed as the reference case (prior art), which includes a total boron concentration of less than 0.5 ppmv in the overall volume flow as an impurity. In the experiments B (1 ppmv of diborane in the overall volume flow), C (4 ppmv of diborane in the overall volume flow), and D (5 ppmv of diborane in the overall volume flow), it was surprisingly possible to observe a reduction in the change in resistance with time as soon as diborane was additionally metered in. This effect is already perceptible in case B, but is particularly marked in case D.

It has been observed that, surprisingly, the rise in resistance with time was reduced as soon as hydrogen with a level of boron contamination higher than 1 ppmv was used in the overall volume flow.

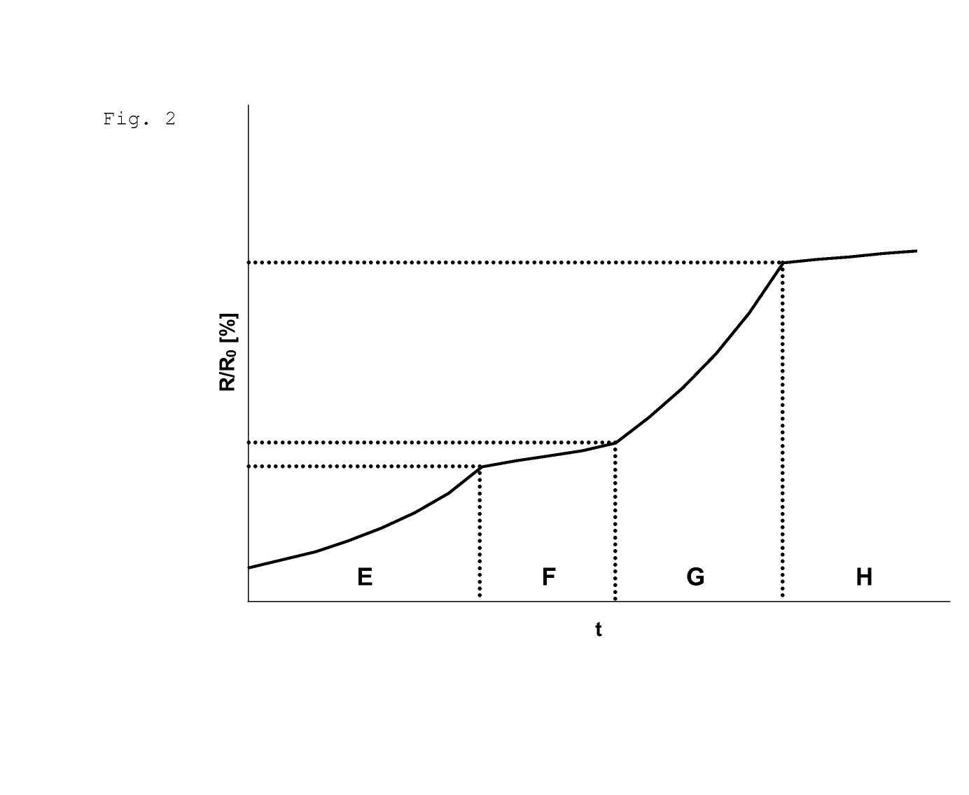

In a further experiment, the metered addition of diborane (4 ppmv based on the overall volume flow) was switched on and off several times. The result is shown schematically in FIG. 2. On the abscissa is plotted the time t, while the ordinate shows the relative resistance R/R₀. Within the time range E, no metered addition of diborane was undertaken. As expected, the resistance profile rises in a strictly monotonous manner. From the time range F, diborane was metered in and the slope of the resistance profile is reduced almost simultaneously with the metered addition. In the time range G, the metered addition is switched off, the result of which is that the resistance rises again as before. In this context, no latency period is discernible. The effect sets in immediately. If the metered addition is switched on once again (range H), the slope of the resistance is once again reduced almost immediately.

The switch between metered addition and no metered addition apparently leads to immediate reactions of the system in the form of different slopes of the relative resistance of the heating elements. If additional layers (for example TBS) were to be responsible for the change in the resistance profile, a distinct latency period would have to be measurable, in which the corresponding layers would be built up or degraded.

In a further experiment, at the same boron concentration (4 ppmv based on the overall volume flow), the temperature of the surface of the heating elements was increased with time.

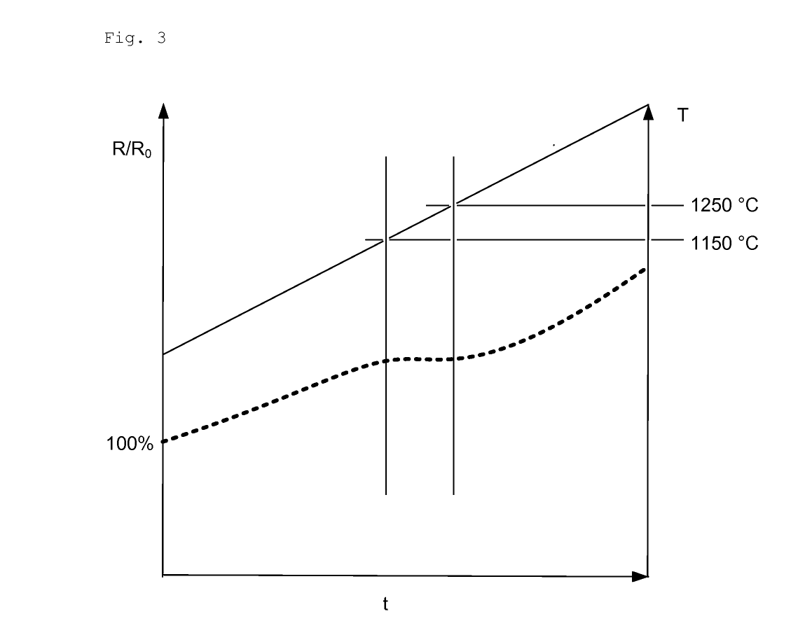

The result of this experiment is shown schematically in FIG. 3.

On the abscissa is plotted the time t, while the left-hand ordinate shows the relative resistance R/R₀ in percent. The right-hand ordinate shows the change in the temperature of the heating elements with time, which was measurable by means of a pyrometer. It was possible to determine that the slope of the resistance curve (dotted line) has a minimum within a range between 1150° C. and 1250° C.

What is claimed is:

1. A process for hydrogenating silicon tetrachloride in a reactor, said method comprising:
(a) providing in the reactor a reactant gas comprising hydrogen, silicon tetrachloride and at least one boron compound selected from the group consisting of diborane, higher boranes, boron-halogen compounds and boron-silyl compounds, wherein a sum of concentrations of all boron compounds is greater than 1 ppmv based on a reactant gas stream;
(b) providing at least one heat exchanger comprising graphite;
(c) providing at least one heating element comprising SiC-coated graphite; and
(d) heating the reactant gas to a temperature of greater than 900° C. at a pressure between 4 and 15 bar, first with the at least one heat exchanger and then with the at least one heating element, wherein the temperature of the at least one heating element is from 1150° C. to 1250° C.

2. The process as claimed in claim 1, wherein the at least one heat exchanger comprises countercurrent heat exchangers made from graphite, which heat the reactant gas with hot product gas comprising trichlorosilane, HCl and unconverted reactant gas.

3. The process as claimed in claim 1, wherein the at least one boron compound is introduced into the reactor together with hydrogen.

4. The process as claimed in claim 1, wherein the at least one boron compound is introduced into the reactor together with silicon tetrachloride.

5. The process as claimed in claim 1, wherein the at least one boron compound is introduced into the reactor both with hydrogen and with silicon tetrachloride.

6. The process as claimed in claim 5, wherein a concentration of all boron compounds in the hydrogen is at least 4 ppmv.

7. The process as claimed in claim 5, wherein a concentration of all boron compounds in the silicon tetrachloride is at least 4 ppmw.

8. The process as claimed in claim 2, wherein the at least one boron compound is introduced into the reactor together with hydrogen.

9. The process as claimed in claim 2, wherein the at least one boron compound is introduced into the reactor together with silicon tetrachloride.

10. The process as claimed in claim 2, wherein the at least one boron compound is introduced into the reactor both with hydrogen and with silicon tetrachloride.

11. The process as claimed in claim 3, wherein a concentration of all boron compounds in the hydrogen is at least 4 ppmv.

12. The process as claimed in claim 8, wherein a concentration of all boron compounds in the hydrogen is at least 4 ppmv.

13. The process as claimed in claim 10, wherein a concentration of all boron compounds in the hydrogen is at least 4 ppmv.

14. The process as claimed in claim 4, wherein a concentration of all boron compounds in the silicon tetrachloride is at least 4 ppmw.

15. The process as claimed in claim 9, wherein a concentration of all boron compounds in the silicon tetrachloride is at least 4 ppmw.

16. The process as claimed in claim 10, wherein a concentration of all boron compounds in the silicon tetrachloride is at least 4 ppmw.
